(19) United States
(12) Patent Application Publication
(10) Pub. No.: US 2006/0123006 A1
(43) Pub. Date: Jun. 8, 2006

(54) Method of limiting on-line access to select web site materials associated with a periodically published publication, to current publication subscribers only

(76) Inventor: Joanne Hayes-Rines, Boston, MA (US)

Correspondence Address: RINES & RINES, 24 Warren St., CONCORD, NH, 03301, US

(21) Appl. No.: 11/005,163

(22) Filed: Dec. 6, 2004

(51) Int. Cl. G06F 17/30; G06F 7/00

(52) U.S. Cl. 707/9

(57) ABSTRACT

A novel method of using mailing or delivery labels or the like of periodic publications to assign thereon preferably both, but at least one of, a single common name and pass code for all publication subscribers-in-good-standing for the period of that publication issue, for use to enable internet web site access to select or private materials in the corresponding web site of the publication, only to such subscribers-in-good-standing or other authorized persons, and only for the period of that publication issue—the common name and/or pass code being changed on the delivery label for subsequent issues.

### FIELD

This invention relates to providing publication readers with access to supplemental or private web site materials, with provision for limiting such access to the publication to current subscribers and other authorized persons only and in a simplified manner.

### BACKGROUND

Many publications, such as magazines, newspapers, advertising brochures and the like, are today associated with their own internet on-line web sites which they invite their readers to access for supplemental and other materials, freely providing their web site “www” code for enabling access by the general public.

There are occasions, however, where it is desirable from the publisher's business point-of-view, to limit web site access (such as to certain web site materials or sections) to special groups only and not the general public at large. This may be for reasons of providing special privileges or services to subscribers or customers only, or to other special groups also, for promotional, select advertising, or other business and financial reasons and benefits residing in the limiting of access to private or select sections of the web site.

Generally, for these and related purposes, on-line access is restricted through typing in or entering on the computer the reader's user name, and the reader's individually assigned PIN (Personal Identification Number) or the like as to which the web site directory maintains a data base or list for comparison and for verification for access to each qualified customer.

The present invention, on the other hand, provides a greatly simplified novel select-group accessing technique particularly useful for the above and other more general purposes, as well, and that also provides an added feature of insuring that the publication subscriber or other authorized person to whom web site access is to be provided is, indeed, a current subscriber in good standing, and further relieves the reader of having to remember his or her PIN etc., and relieves the web site portal monitoring from having to deal with lists of subscribers and PINs.

### OBJECTS OF INVENTION

A primary object of the invention, accordingly, is to provide a new and improved and simplified method of restricting web site-portion access to current authorized persons and publication subscribers-in-good-standing only, and only for the period they remain in such good standing as subscribers (or other special groups).

An additional object is to provide a novel method of doing business that insures the benefits of continually providing special web site access and services therein to publication subscribers only.

Other and further objects will be explained hereinafter and are more particularly delineated in the appended claims.

### SUMMARY

In summary, however, the invention embraces a method of providing for the limited accessing of private sections of on-line web site materials associated with a periodically issued and delivered publication, by only the then-current subscribers to that publication, to whom such publication issue is sent, that comprises, providing on mailing or delivery labels of the periodically issued publication, individually addressed to each respective subscriber, preferably both a single common user name and a single common pass code for each publication issue in order that on-line access may be obtained to said private sections of the web site material by all current issue subscribers through their using the common user name and common pass code on that issue for such web site accessing; and changing at least one of said common user name and common pass code provided on the label of subsequent publication issues, thereby to insure such access only to the then-current issue publication subscribers or other authorized readers, and only for the period of that issue(s).

Preferred and best mode techniques for the implementation of the invention are hereinafter set forth.

### DESCRIPTION OF PREFERRED EMBODIMENT(S) OF THE INVENTION

The invention is of a nature that it is believed does not require drawings to describe the operation.

Consider, as an example, the use of the invention to permit the current subscriber in-good-standing of a monthly magazine or newsletter to have the benefit and privilege of private access to select materials on the magazine's corresponding internet web site, including, as illustrations, the total content instead of limited portions of that monthly issue, access to back issues, special information, special promotions, etc. In accordance with the invention, as before stated, the current subscribers will have provided to them in the current monthly issue of the magazine sent to them, preferably both a special common user name and a special common pass code or password for that month, printed on the mailing or delivery label of the issue as individually addressed to each subscriber. All the subscribers in current good standing, of course, are sent the same issue, and their respective delivery labels will bear the same single and common “user name” and pass code for the month of that issue, for enabling recognition at the web site portal in granting access to the special web site section and materials, and just for that month. The next month's issue will contain at least one of, and preferably both of a changed or different common user name and pass code, providing for access by all current subscribers for that month only, and so on.

This simple technique relieves the web site of the need to update the subscriber data base as renewals are received and only requires the web site access monitoring to recognize but a single assigned name and a single assigned pass code for all the subscribers, (or other special groups to whom the magazine is sent for the complete month). The reader does not have to remember an individual PIN or other accessing steps and security is automatically provided in that only the intended current subscribers-in-good-standing to whom each issue is sent, receives the special accessing code information that is only useful for that month. The publication accounting records identify subscribers not in good-standing and they automatically are not sent the next issue, and, therefore, they do not have access to the private information on the web site.

Clearly, the periodicity of the publication need not be monthly, but may also be any desired shorter or longer period; in some instances, one only of the common user name or the common pass code may be used; and the technique of the invention is not restricted to only magazines, newsletters, newspapers, advertisements, etc.; and further modifications will also occur to those skilled in the art, such being intended to be embraced within the spirit and scope of the invention as defined in the appended claims.

What is claimed is:

1. A method of providing for the limited accessing of private sections of on-line web site materials associated with a periodically issued and delivered publication by only the then current subscribers to that publication or other authorized persons, to whom such publication issue is sent, that comprises, providing on mailing or delivery labels of the periodically issued publication, individually addressed to each respective subscriber, a single common user name and a single common pass code for each publication issue in order that on-line access may be obtained to said private sections of the web site material by all current issue subscribers through their using the common user name and common pass code on that issue for such web site accessing; and changing at least one of said common user name and common pass code provided on the label on subsequent publication issues, thereby to insure such access only to then current issue publication subscribers, and only for the period of that issue(s).

2. The method of claim 1 wherein there is added to the subscriber on-line accessing, other special groups of authorized persons to whom the publication is also sent.

3. The method of claim 1 wherein the corresponding common user name and pass code is provided only in the current delivered subscriber's issue of the publication for web site accessing by the subscriber during the period of that issue only.

4. The method of claim 1 wherein both the common user name and common pass code are changed for the subsequent publication issue(s).

5. A method of doing business, that comprises, using the periodic publication subscriber-addressed delivery labels of each issue of the publication, also for assigning thereon one or both of a single common name and a common pass code for all the publication subscribers or other authorized persons for their use in accessing internet web site materials associated with the publication; and changing the common name and/or common pass code on the delivery labels on subsequent issues to ensure access only to subscribers-in-good-standing or other authorized persons at the time of that issue, and only useful for web site access for the period covered by that issue(s).
